(19) United States
(12) Patent Application Publication
(10) Pub. No.: US 2025/0042786 A1
(43) Pub. Date: Feb. 6, 2025

(54) BUOYANT PERMEABLE REACTIVE BARRIER

(71) Applicant: H2nanO Inc., Kitchener (CA)

(72) Inventors: Tim Leshuk, Kitchener (CA); Frank Gu, Toronto (CA); Zac Young, Kitchener (CA)

(21) Appl. No.: 18/715,920

(22) PCT Filed: Dec. 1, 2022
(86) PCT No.: PCT/CA2022/051758

§ 371 Date: Jun. 3, 2024

Related U.S. Application Data
(60) Provisional application No. 63/284,758, filed on Dec. 1, 2021.

(51) Int. Cl. C02F 1/72; C02F 1/32; C02F 3/28; C02F 101/10; C02F 101/16; C02F 101/32

(52) U.S. Cl. CPC C02F 1/725; C02F 1/32; C02F 3/2826; C02F 2101/101; C02F 2101/16; C02F 2101/322; C02F 2101/40; C02F 2305/10

(57) ABSTRACT

A buoyant permeable reactive barrier for blocking the emission of greenhouse gasses (e.g., methane) and volatile compounds (e.g., ammonia, sulfur) from a body of water is provided. The buoyant reactive barrier includes a plurality of buoyant reactive barrier elements arranged in one or more substantially planar layers on the surface of the water. The reactive barrier elements are selected to provide for selective permeability of certain compounds/gasses through the buoyant barrier, while blocking or reacting with other compounds/gasses. At least a subset of the barrier elements may be provided with a catalyst for catalyzing the oxidation of volatile compounds to less volatile products. At least a subset of the barrier elements may be sufficiently large to impart wind and wave resistance to the reactive barrier. The buoyant barrier may include a gelatinous extracellular polymeric matrix that fills the interstitial spaces between the plurality of buoyant reactive barrier elements.

### TECHNICAL FIELD

The embodiments disclosed herein relate to containment and reduction of malodorous and greenhouse gases, and, in particular to a buoyant permeable reactive barrier for reduction of malodorous and greenhouse gas emission from tailings ponds and waste reservoirs.

### INTRODUCTION

Tailings ponds are used to contain contaminants, byproducts and waste materials generated from mining operations, oil and gas refinement and other industrial processes. Similarly, waste lagoons are used to contain refuse water at water treatment facilities and agricultural operations. Tailings ponds, waste lagoons, and the like are typically bodies of water that are open to the environment, whereby greenhouse gasses (GHGs) and other volatile or malodorous compounds in aqueous solution may evaporate into the air at the surface of the water. It has been estimated that tailings ponds emit 5-15% of the total GHG emissions in surface mining operations.

To prevent the escape of greenhouse gases and other volatile chemicals from tailings pods and the like, a tarp-like barrier that is impermeable or selectively permeable to certain chemicals may be placed or floated on the surface of the body of water to prevent the escape of harmful chemicals into the air. A limitation of tarp-like barriers is that they must be held in place and may become displaced by weather activity such as wind, rain, and waves. Installation of tarp-like barriers can be expensive and labour-intensive, especially if the body of water is irregularly shaped. Another challenge is the repositioning of the barrier when it becomes displaced.

Many existing tarp-barriers are stiff and inflexible, meaning they do not easily conform to the shape of the water's surface as it changes due to weather activity, waves, or other disturbances, such as the addition of more wastewater. Rigid tarp-barriers, while relatively impermeable, may be susceptible to tears and punctures from weather, wildlife, or general stress. Once the barrier has been torn or punctured, it permanently loses its integrity and must be repaired or replaced manually.

Existing impermeable tarp-barriers may also significantly impede certain natural processes such as the exchange of oxygen from the atmosphere into the body of water. In many environmental remediation applications these natural processes are desirable; for example, the transfer of oxygen to the water may promote biological growth and speed up oxidative treatment processes. Many tarp-barriers also fully block sunlight, impeding the growth of plants and other photosynthetic organisms which may otherwise contribute to remediation.

Another drawback of existing tarp-barriers is that harmful chemicals, while prevented from evaporating into the air, will accumulate over time in the body of water and may be released into the surrounding environment if the body of water is not properly contained. Accumulation of harmful chemicals in the body of water also increases the environmental consequences of a potential leak or contamination. Furthermore, tarp-barriers may not prevent the release of certain malodourous compounds.

Accordingly, there is a need for a new and improved buoyant reactive barrier that is easily installed, can dynamically adapt its shape in response to weather activity, and is configured to trap gas emissions and catalyze the conversion of greenhouse gases and volatile chemicals into less harmful products.

### SUMMARY

A buoyant permeable reactive barrier (BPRB) is provided, consisting of a plurality of buoyant reactive barrier elements (BRBEs), wherein these reactive elements include, at least in part, a catalyst. Methods of manufacture of such BPRBs are envisioned. A method of using such a BPRB for water and/or gas treatment is also envisioned, wherein the BPRB may be floated at about the surface of a contaminated body of water and thereby cap, block, impede, slow, or delay the emission of volatile compounds from the water beneath (or alternately, the transfer of volatile compounds from the air above into the water beneath), while simultaneously providing a treatment chemical reaction to the water or the volatile compounds, mediated by the catalysts included in the reactive barrier elements.

According to an embodiment, there is a buoyant permeable reactive barrier comprising a plurality of buoyant reactive barrier elements at a surface of a body of water. At least a subset of the buoyant reactive barrier elements includes a catalyst (e.g., TiO₂) for oxidation of one or more volatile compounds (e.g., methane, ammonia, sulfur). Interstitial spacing between the plurality of reactive barrier elements slows the diffusion of the one or more volatile compounds across the buoyant permeable reactive barrier and facilitate reaction of the catalyst with at least one of the volatile compounds.

The catalyst may be an electrocatalyst, activatable by electric current. The catalyst may be a photocatalyst activatable by sunlight selected from the group of: titanium oxides, silver chloride, silver phosphate, iron oxides, bismuth oxides, tungstate, carbon nitrides, cerium oxides, cobalt oxides, or cobalt phosphates, manganese oxides, tin oxides, tungsten oxides, zinc oxides, or a combination thereof. The buoyant reactive barrier may further include an adsorbent for retaining the one or more volatile compounds in reactive proximity to the catalyst.

The plurality of buoyant reactive barrier elements may be constructed of hollow balls, hollow glass shells, plastic beads, microspheres, microparticles, microplastics, textiles, fabrics, geotextiles, membranes, fibers, plates or platelets. The plurality of buoyant reactive barrier elements may include a first subset of reactive barrier elements having a diameter between 10-500 μm. The buoyant barrier may include a second subset of reactive barrier elements having a diameter greater than 1 mm for imparting wind and wave resistance to the buoyant barrier. The plurality of buoyant reactive barrier elements may be connected by chemical bonding, magnetism or physical tethers.

The buoyant reactive barrier may further include a biofilm having a gelatinous extracellular polymeric matrix that fills the interstitial spaces between the plurality of buoyant reactive barrier elements. An enzyme catalyst may be embedded in the gelatinous extracellular polymeric matrix.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. The drawings are provided for illustration purposes only and are not drawn to scale. In the drawings:

FIG. 1 is top and side views of a buoyant permeable reactive barrier, according to an embodiment;

FIG. 2 is a diagram of a buoyant permeable reactive barrier formed of impermeable buoyant microspheres, according to an embodiment;

FIG. 3 is a diagram of a multi-layer buoyant permeable reactive barrier, according to an embodiment;

FIG. 4 is a diagram of a buoyant permeable reactive barrier for emissions and odor blocking, according to an embodiment;

FIG. 5 is a diagram of oxidative photocatalysis to transform methane to carbon dioxide by a buoyant permeable reactive barrier, according to an embodiment;

FIG. 6 is a graph quantifying the barrier effect of the buoyant permeable reactive barrier in FIG. 5 on methane emission;

FIG. 7A is a graph quantifying the transformation of aqueous methane to less volatile products by the barrier of FIG. 5;

FIG. 7B is a graph quantifying the complete oxidation of methane to carbon dioxide by the barrier of FIG. 5;

FIG. 8A is a diagram of oxidative photocatalysis to transform ammonia to nitrate by a buoyant permeable reactive barrier, according to an embodiment;

FIG. 8B is a graph quantifying the transformation of aqueous ammonia to nitrate by the barrier of FIG. 8A;

FIG. 8C is a graph showing kinetics of the transformation of ammonia shown in FIG. 8B;

FIG. 9 is a graph quantifying a buoyant permeable reactive barrier effect on volatile fatty acid emissions, according to an embodiment; and

FIG. 10 is a graph quantifying a buoyant permeable reactive barrier effect on toluene emissions, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

References herein to “body of water” means tailings ponds, waste lagoons/reservoirs, containment tanks, and the like, that are typically located outdoors and exposed to air. References herein to “CO₂e” means carbon dioxide equivalents.

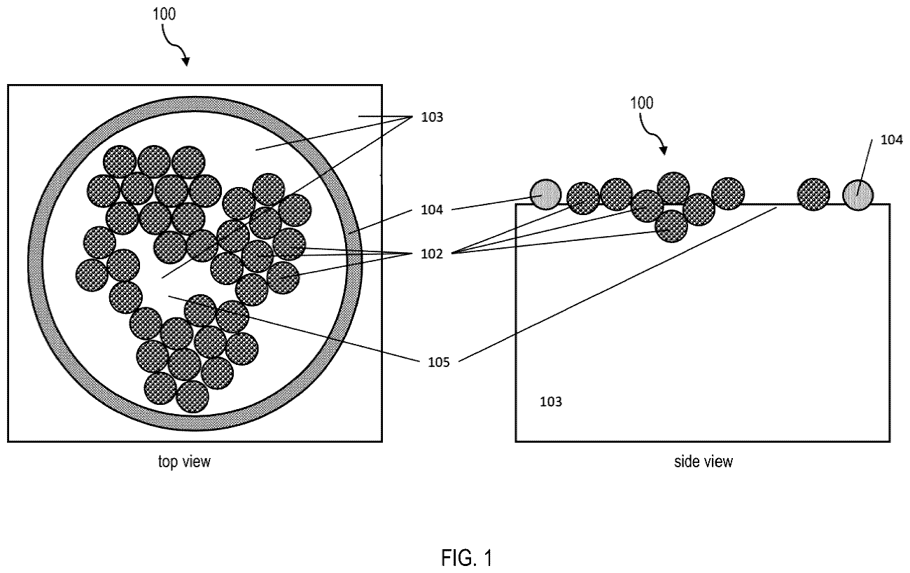

Referring to FIG. 1, shown therein are top and side views of a buoyant permeable reactive barrier (BPRB) 100. The BPRB 100 is a collection of a plurality of buoyant reactive barrier elements (BRBEs) 102 that float at or near the surface of a body of water 103. BRBEs 102 are buoyant and, due to surface forces, spread out over the surface of the water rather than aggregating in a mass. The BRBEs 102 may be fashioned in the form of buoyant balls, hollow balls, hollow glass shells, plastic beads, buoyant photocatalysts (e.g., the composite materials disclosed in Canadian patent filing CA3041214A1), microspheres, microparticles, or microplastics; pieces of textile, fabric, geotextile, membranes, or fibers; plates or platelets; etc., provided that at least a subset of the BRBEs 102 are included with a catalyst therein.

The BRBEs 102 may all be of the same type or class of material or may comprise several different types of BRBEs 102 (e.g., buoyant photocatalysts and buoyant microfibers), assembled to form a BPRB 100. The size of BRBEs 102 may also be varied to provide the BPRB 100 with desirable properties. For example, two BRBEs 102 types of differing size may be included in the BPRB 100, whereby the smaller BRBEs (10-500 μm diameter) block gas escape through the BPRB 100 provides surface area for a catalytic reaction, while the larger BRBEs (>1 mm diameter) provides the BPRP 100 resistance against wind that may disrupt the smaller BRBEs 102.

The BRBEs 102 may either be connected to each other through chemical bonding, magnetism, physical tethers or strands, etc., or may be separated from each other, each floating independently in the same general area. Such independent BRBEs 102 may be bounded by the natural shore or boundary of the body of water 103, or optionally by artificial boundaries or enclosures, such as a cordon of buoyant containment booms 104. The BRBEs 102 may be arranged together in a single layer at about the water 103 surface or may be stacked in an ordered or disordered assembly, e.g., in the form of multiple layers of BRBEs 102 at the surface of the body of water 103.

Together, the plurality of BRBEs 102 floating in an area comprise a BPRB 100. A feature of the BPRB 100 is its composition by discrete BRBEs 102, which enables a BPRB 100 to be easily spread over a custom geometry of the water 103 surface, and to naturally conform to the size and surface profile of the water 103, without the need to re-engineer or re-design a custom BPRB 100 for each use application. Accordingly, diverse BPRB 100 geometries may be achievable from a single type of BRBE 102 arranged in different configurations. This feature also enables the BPRB 100 to be dynamically reactive to environmental conditions, with the ability to flow and deform with the water 103 surface, or rise and fall with waves, and to “self-heal” the BPRB 100 by filling in gaps 105 (i.e., open water surface area between BRBEs 102) formed in the BPRB 100 by natural realignment of the arrangement of BRBEs 102 within the BPRB 100. This feature is especially advantageous for relatively large bodies of water 103, where spreading of a large, 2-dimensional vapor barrier as a single uniform sheet or piece may be impractical or undesirable.

It should be noted that a BPRB 100 need not uniformly cover the surface of a body of water 103, but may instead be heterogenous, with BRBEs 102 more or less concentrated in certain areas near the surface of the water 103, with gaps 105 of various distances existing between the BRBEs 102. Such gaps 105 or spacings between the BRBEs 102 may be pre-engineered to be of a uniform dimension and fixed with time. Alternatively, the gaps 105 may be formed and disappear naturally and dynamically as BRBEs 102 are moved relative to each other by the action of wind, waves, and water currents. Indeed, gaps 105 in the BPRB 100 may be a desirable feature to tune its semi-permeability to volatile compounds.

A feature of the BPRB 100 is permeability to certain compounds. For many environmental remediation applications, it is not necessarily desirable to create an entirely impermeable barrier to contaminant transport or flux, as an impermeable barrier may interfere with concomitant natural processes, such as groundwater flows. Similarly, it is considered that frequently it would be undesirable to cap the surface of a body of water with an entirely impermeable barrier, as this could significantly alter natural processes occurring at or beneath the water surface, for example, the transport of oxygen from the air to the water below. Furthermore, for contaminants whose source originates within the body of water (e.g., H₂S produced by sulfur-reducing microorganisms), it may be undesirable to fully enclose the water in an entirely impermeable barrier, as contaminants could be trapped and build-up in the water, with concentration increasing with time. Therefore, for environmental remediation applications, it is frequently desirable to allow some exchange of compounds across the barrier, either selectively, or reactively.

According to various embodiments, the BPRB 100 could be semi-permeable, meaning either permeable to selected chemical compounds, or generally permeable to a number of compounds, by providing a catalytically-mediated chemical reaction to modulate contaminants permeating through the barrier 100. The permeability of the BPRB 100 may be engineered in a variety of ways, by, for example: control of the gaps 105 in the BPRB 100 or by control of the BRBEs 102 themselves; reducing the thickness or modulating the chemical composition of the BPRB 100 or BRBEs 102 such that components may dissolve into the barrier 100 and move across it in solution; or by the interstitial spacing between the BRBEs 102 comprising the BPRB 100 (which may also be controlled through choice of dosing of BRBEs 102 per area of open water). Accordingly, either the BPRB 100 or BRBEs 102 may be themselves engineered to be semi-permeable, with no further permeability imparted due to the arrangement of BRBEs 102 within the BPRB 100. Alternatively, or in combination, the BRBEs 102 may themselves be entirely impermeable, and semi-permeability is introduced to the barrier by the gaps 105, or interstitial spacing between the BRBEs 102 making up the BPRB 100.

Generally, the density or concentration of BRBEs 100 is dependent on the application. For example, in methane treatment applications a combination of 0.3-1 kg/m² small BRBEs (10-500 μm diameter) and 3.3 kg/m² large BRBEs (>1 mm diameter) may be used.

In certain embodiments, the BPRB 100 prevents evaporation of water from the body of water which it covers. This property is beneficial for applications where it is desirable to keep a reservoir at a specific water level or applications where evaporation effectively increases the concentration of target contaminants. In order to achieve a reduction in water evaporation rate, the BPRB 100 may be designed to be impermeable to water vapor in one or more ways, for example: selecting the material composition of constituent BRBEs 102 to make them hydrophobic, designing BRBEs 102 to have a larger size (e.g., >1 mm diameter) to avoid their full wetting, or having a multilayer BPRB 100 whereby the bottom layer is wetted but water vapor is blocked by one or more dry upper layers. The BPRB 100 may also reduce water evaporation by blocking/absorbing incoming solar radiation. BRBEs 102 may act as heat sinks, absorbing solar radiation and dissipating it into the surrounding air, such as through engineering their optical emissivity. In specific embodiments, BRBEs 102 may be engineered to be reflective, either by coating with a reflective material or using a reflective material for the BRBEs themselves. Reflective BRBEs 102 can then form a BPRB 100 which will act as a reflective shield and prevent radiative heating of the covered body of water.

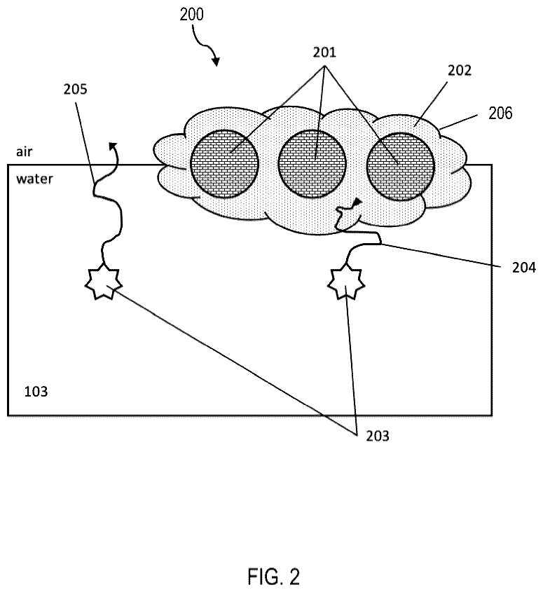

Referring to FIG. 2, shown therein is a buoyant permeable reactive barrier (BPRB) 200, according to an embodiment. The BPRB 200 is formed from a plurality of impermeable buoyant microspheres 201 (i.e., BRBEs in FIG. 1) arranged in an assembly at the surface of a body of water 103, upon which a biofilm 206 is grown. A gelatinous extracellular polymeric substance (EPS) 202 of the biofilm 206 may, at least partially, fill in the spacing between the buoyant microspheres 201. A diffusion path 204 of dissolved volatile contaminants 203, through the interstitial holes between the microspheres 201, is impeded by the biofilm 206, or its EPS 202, in comparison to a natural diffusion path 205 in the absence of the BPRB 200. Here the biofilm 206 serves a dual role in the BPRB 200, by firstly connecting the BRBEs 201 together through the adhesive qualities of the EPS 202, and secondly serving as semi-permeable substance in-filling the interstitial spacing, pores, and gaps between the BRBEs 201 in the BPRB 200, thereby modulating the effective diffusivity of chemical compounds through the BPRB 200 as a whole. The presence or absence of biofilm 206 formation on the BPRB 200 can be engineered, for example, through biostimulation with nutrients added with the BRBEs 201, or through engineering the BRBEs 201 to be biocidal and biofouling resistant, respectively.

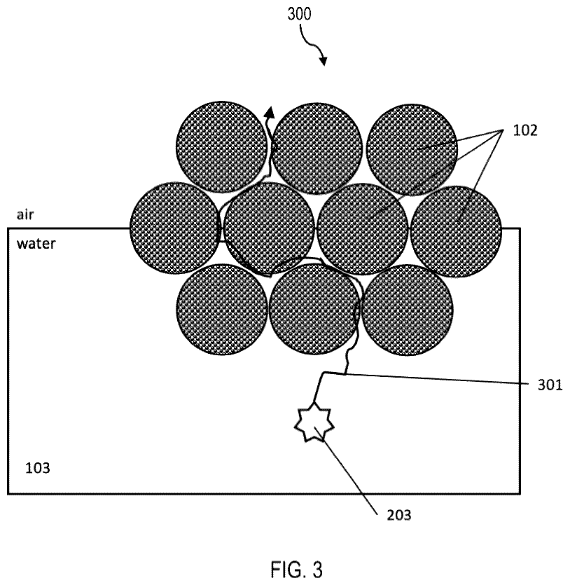

Referring to FIG. 3, shown therein is a multi-layer buoyant permeable reactive barrier (BPRB) 300, according to an embodiment. The BPRB 300 is formed of a plurality of buoyant reactive barrier elements (BRBEs) 102 arranged in two or more layers at the surface of a body of water 103. The permeability of the BPRB 300 to volatile contaminants 203 may be due to the interstitial spacing or gaps created in a close-packed surface monolayer of BRBEs (in the case of a single layer BPRB, i.e., BPRB 100 in FIG. 1), or for multilayer stacks of BRBEs 102, a tortuous diffusion path 301 created by the openings between the stacked BRBEs 102.

Generally, the multilayer BPRB 300 may be formed either stochastically (due to inter-BRBE connections or adhesive forces causing the BRBEs 102 to stack to form multi-layers) or by use of engineered containment structures. The multilayer BPRB 300 may be formed via successive deployments, whereby an initial monolayer of BRBEs 102 is deployed followed by further addition of BRBEs 102, either of the same type as the monolayer BRBEs 102 or of a different size, shape, and/or composition. Alternatively, a multilayer may be formed by a single deployment of BRBEs 102, whereby the mass loading per surface area is selected such that the BPRB 300 consists of sufficient BRBEs 102 for multiple layers of coverage. For example, a BRBE with average diameter of 300 μm and density of 0.96 kg/m³ will form a multilayer BPRB when deployed evenly at a surface loading of 0.8 kg/m². The stacking of layers can be controlled dynamically by expanding or contracting the containment area of the BPRB, for example, by moveable containment booms. By contracting a single layer BPRB to less than a sum of the water surface area occupied by the BRBEs, BRBEs can be forced to stack (i.e., similar to a Langmuir trough technique). Conversely, provided inter-BRBE connections or adhesive forces are less than the force of gravity, expansion of a multi-layer BPRB's containment area will allow stacked layers of BRBEs to fall off each other and expand to a mono-layer BPRB covering the larger area.

The permeability of the BPRB 300 may be constant over time or may vary dynamically with the shifting arrangement of BRBEs 102. The permeability of the BPRB 300 may be selective to certain compounds, e.g., volatile contaminants 203. This feature is beneficial to only allow particular compounds to pass through the barrier 300 and undergo a catalytic reaction, which may increase efficiency of the BPRB 300 by focusing its reactivity on only the selected compounds.

According to various embodiments, the BPRB 100, 200, 300 in FIGS. 1-3 may be designed to be semi-permeable to H₂S but impermeable to water. This will prevent evaporation of water while allowing H₂S to be passed into the BPRB 100, 200, 300 and reactively treated. Selective permeability may be imparted to the BPRB 100, 200, 300 by several mechanisms, e.g., through the use of various compound-selective adsorbents (chemical or physical adsorption) or molecular sieves, or through modulation of polarity of the BPRB 100, 200, 300 or BRBEs 102 (e.g., creating a hydrophobic barrier that is largely impermeable to water, but semi-permeable to organic compounds). The BPRB 100, 200, 300 may also be designed to be fully permeable to one or more compounds, where the “barrier” effect is imparted through simply slowing, retarding, or delaying the transport of compounds across the BPRB 100, 200, 300; for example, the slow diffusion of volatile contaminants through a multilayer assembly of BRBEs 102 is shown in FIG. 3.

The “barrier” effect of the BPRB 100, 200, 300 may alternatively be imparted by neither decreasing the permeability, nor slowing the permeation of compounds, but rather by enabling full permeation of compounds through the barrier unimpeded, and then selectively reacting certain compounds to transform them into a new compound, such that the total flux of the original compound across the BPRB 100, 200, 300 would appear to have encountered a barrier. For example, the BPRB 100, 200, 300 may be fully permeable by organic volatile contaminants partitioning through the BPRB from the water below, but also impart sufficient reactivity to oxidatively degrade or transform these contaminants such that the total flux of volatile contaminants across the BPRB 100, 200, 300 is diminished.

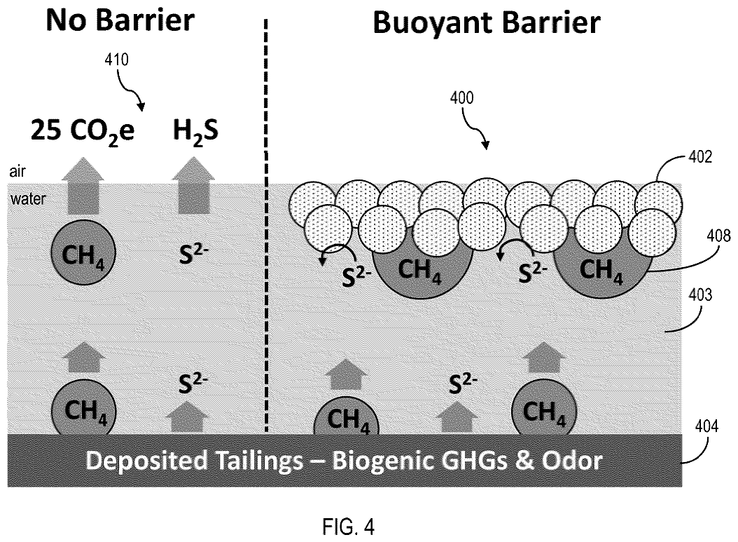

Referring to FIG. 4, shown there is a diagram of a buoyant permeable reactive barrier (BPRB) 400 for emissions and odor blocking, according to an embodiment. In FIG. 4, the left side shows baseline emissions 410 of CH₄ and H₂S released from deposited tailings 404 in a body of water 403. Without the BPRB 400, CH₄ is released into the atmosphere, contributing 25 kg CO₂ₑ to greenhouse emissions per kg of CH₄ emitted. Malodorous H₂S is also released into the air in the absence of the PBRB 400.

The right side of FIG. 4 shows blocking of emissions and odor when the PBRB 400 is present. Aqueous methane and sulfur released from the deposited tailings 404 are prevented from evaporating and are trapped by the BRBEs 402 that make up the PBRB 400. The trapped methane may agglomerate as methane gas bubbles 408 retained on the bottom of the PBRB 400. The trapping of emissions at the bottom surface of the PBRB 400 may facilitate in-situ emissions treatment to convert more harmful GHGs like methane to less harmful compounds and further reduce emissions.

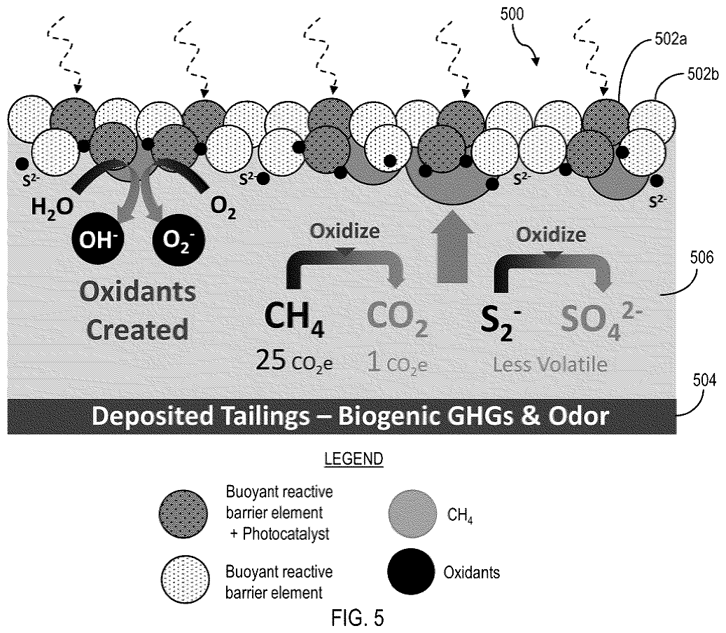

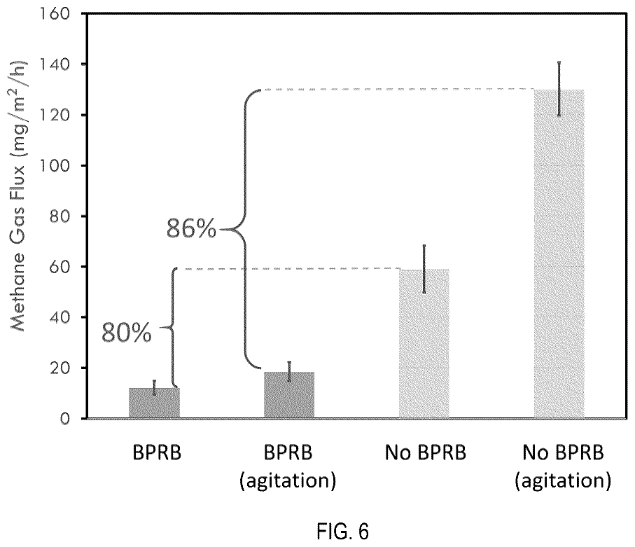

Referring to FIG. 6, shown therein is a graph illustrating the barrier effect of the BPRB 500 in FIG. 5 on methane gas emissions. Methane gas flux through BPRBs formed of BRBEs having a catalyst are compared to the absence of a BPRB. When a BPRB is present, more methane is retained in the water phase, and prevented from emitting to the above headspace air (such as by being blocked by the BPRB, or converted to carbon dioxide by the catalyst) than in the absence of the BPRB, resulting in ˜80-86% less methane gas flux through the BPRB compared to a bare water surface when measured using a combustible gas sensor (e.g., Ventis MX4).

Also shown in FIG. 6 is the effect of agitation on methane gas flux in the presence or absence of a BPRB. In the absence of the BPRB, there is a large increase in the gas flux of methane from the bare water surface, primarily due to disturbances in the layer coverage caused by agitation and an increased mass transfer rate of methane bubbles. In contrast, with the BPRB present, agitation only slightly increases the methane gas flux from the surface of the water, demonstrating the BPRB's resilience to disturbances, and beneficial self-healing properties to still block methane emissions despite higher mass transfer from mixing.

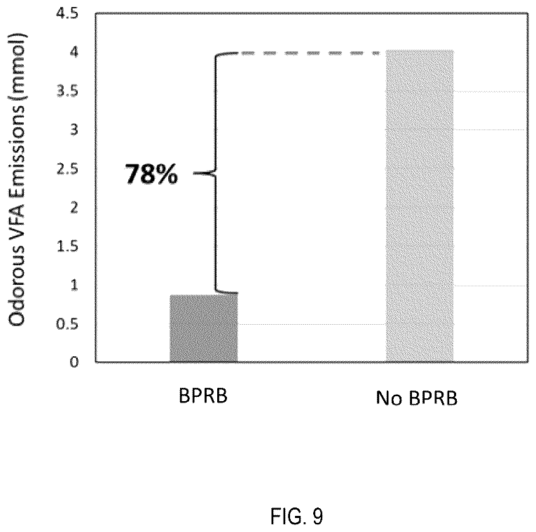

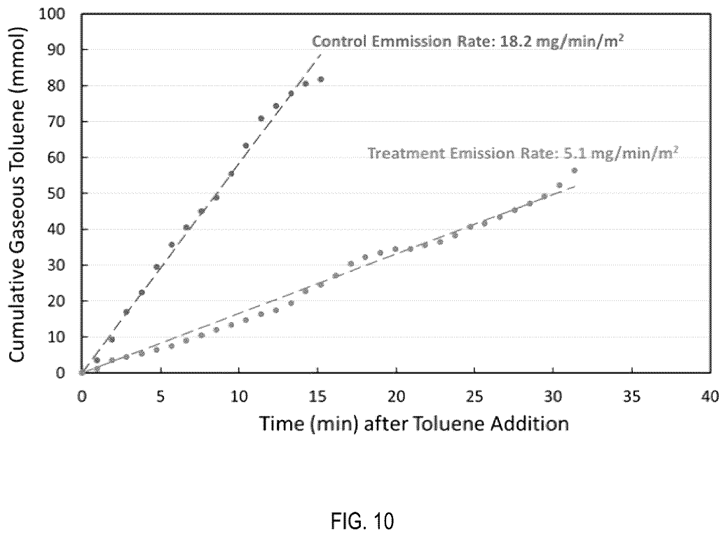

The barrier effect of BPRB 500 may also provide for blocking emissions of volatile fatty acids (VFA) and toluene as shown in FIGS. 9 and 10, respectively. As shown in FIG. 9, the presence of the BPRB 500 results in a 78% reduction in emission of VFAs compared to when no BPRB is present. As shown in FIG. 10, the presence of the BPRB results in a toluene emission rate of 5.1 mg/min/m² compared to an emission rate of 18.2 mg/min/m² when no BPRP is present.

The BPRBs described herein may be imparted with reactive properties to facilitate the reactive modification or transformation of compounds permeating through the BPRB. Such reactivity is preferably imparted to the BPRB through the use of a catalyst, such that the reactivity may be continuously used to transform permeating chemical compounds. This catalyst element may be homogenous (dissolved molecularly within the BPRB, such as in interstitial inter-BRBE volumes or pores) or heterogenous (an insoluble material included within the BPRB), and either inorganic, organic, or biological. Preferably, the catalyst is an inorganic heterogenous photocatalyst, such as a large bandgap semiconducting oxide like TiO₂, wherein the catalyst may be activated by absorption of light to initiate a reactive transformation of a permeating substrate compound. Other photocatalysts contemplated include silver chloride or phosphate, iron oxide, bismuth oxides or tungstate, carbon nitrides, cerium oxides, cobalt oxides or phosphates, manganese oxides, tin oxides, tungsten oxides, zinc oxides, noble or transition metals, single atom catalysts, or any of the above compounds or derivatives. However, in other embodiments, the catalyst could be an enzyme, or a variety of enzymes (e.g., a bioprocess) contained within a biological cell or microorganism included in the BPRB.

In one embodiment, a biofilm grown on or within the BPRB could be considered as a plurality of enzymatic catalysts. In another embodiment, the catalysts may be electrocatalysts, wherein the BPRB could be engineered to be electrically conductive, such that the electrocatalysts could be activated with electricity, provided either by a connection to an electrical power system, or via a buoyant photovoltaic module included within the BPRB.

The reactivity of any of these exemplary PBRBs may be further augmented or improved through the use of chemical reactants (either homogenous, or heterogenous), or adsorbents. As an example, zero valent iron (ZVI) nanoparticles may be included within the BPRB, wherein the electrochemical reductive properties of the ZVI may also contribute to the transformation of target permeating substrates, e.g., the reduction of halogenated hydrocarbons. In another embodiment, a reactive chemical may be included in the BPRB, either homogenously, or in discrete reservoirs or capsules that release the chemical over time. In another example ion-exchange resin beads may be included within the BPRB, to locally release ions within the vicinity of the BPRB, e.g., to supplement other (catalytic) reactions co-occurring.

In other embodiments, adsorbents may be included within the BPRB, to selectively adsorb certain permeating compounds, and thereby further retain these compounds in the vicinity (i.e., reactive proximity) of reactive agents (either chemical compounds or catalysts) such that the compounds may be more efficiently transformed by the reactive agents. In certain embodiments, the catalyst and adsorbent may be the same compound, e.g., in the inclusion of certain types of activated carbon, especially amine-functionalized activated carbon, where these materials may serve as adsorbents, but also reactively transform adsorbates, such as in the chemisorption of H₂S. Preferred adsorbents include activated carbons, optionally N-doped, amine-modified, or S-doped, as well as ion exchange materials such as ion exchange resins or polyelectrolytes, as well as zeolites or metal-organic frameworks.

The reactive or adsorptive properties of the BPRB may be introduced during manufacturing, deployment, or over time once deployed, and may be relatively constant, or dynamically changing with time. In one embodiment, the BPRB as deployed may be minimally reactive, however upon growth of a biofilm on or within the BPRB, biological reactivity may be imparted over time. The catalysts, reactive compounds, and adsorbents may be distributed in the BPRB either homogenously, or as a coating applied to the BPRB; as an inclusion or coating on the BRBEs; or retained interstitially within the assembly of BRBEs.

The reactivity of the catalyst and reactive elements may be oxidative or reductive, and in a preferred embodiment, may be designed to transform permeating contaminants within the BPRP to less-harmful contaminants or compounds. In another preferred embodiment, the BPRB may be used to oxidize permeating methane to CO₂, to reduce the greenhouse gas impact of a methanogenic water body. In another preferred embodiment, the BPRB may be used to reduce dissolved permeating CO₂ or (bi) carbonate in the aqueous phase to methane, hydrocarbons, or value-added chemical products, to be used as either fuel or chemical feedstocks. In this embodiment, the BPRB may be used to cap a flue gas scrubbing solution, to transform scrubbed CO₂ into value-added products.

Referring to FIG. 5, shown therein is a diagram of oxidative photocatalysis to transform methane to carbon dioxide, according to an embodiment. A buoyant permeable reactive barrier (BPRB) 500 may be formed by a plurality of buoyant reactive barrier elements (BRBEs) 502a, 502b wherein at least a subset of the BRBEs 502a include a photocatalyst (e.g., TiO₂). The photocatalyst is activatable, upon absorbing solar radiation (dashed arrows), to catalyze a chemical reaction to transform volatile compounds released from deposited tailings 504 in a body of water 506 into less volatile products. For example, the photocatalyst may catalyze the transformation of methane to carbon dioxide, as shown. The carbon dioxide may be further retained in the water provided the pH of the water is alkaline, through conversion to non-volatile carbonate or bicarbonate. The photocatalyst may further catalyze the oxidation of sulfur to less volatile sulfate.

Upon activation by sunlight, the photocatalyst produces oxidants (e.g., O₂⁻, OH⁻) that react with the methane and/or sulfur according to the following chemical equations:
(1) oxidation of methane to carbon dioxide, e.g., CH₄+O₂→CH₃OH→CO₂+H₂O;
(2) oxidation of sulfur to sulfate, e.g., S₂+4 O₂→2 SO₄;
(3) activation of catalyst: TiO₂+hv→e_{CB}⁻+h_{VB}⁺;
(4) regeneration of catalyst: e_{CB}⁻+O₂→O₂⁻ and h_{VB}⁺HO⁻→HO⁺,
   where hv represents a photon of light with frequency v (h is Planck's constant), e_{CB}⁻ represents an excited electron residing in the conduction band of the TiO₂, and h_{VB}⁺ represents an electron-hole residing in the valence band of the TiO₂.

Through the above reactions ˜25 CO₂ₑ of methane may be transformed to ˜1 CO₂ₑ of carbon dioxide. Similarly, malodorous sulfur may be transformed to less volatile sulfate. The products generated by the above chemical reactions (1)-(4) are substantially prevented from evaporating into air by the BPRB 500 and are retained in aqueous solution.

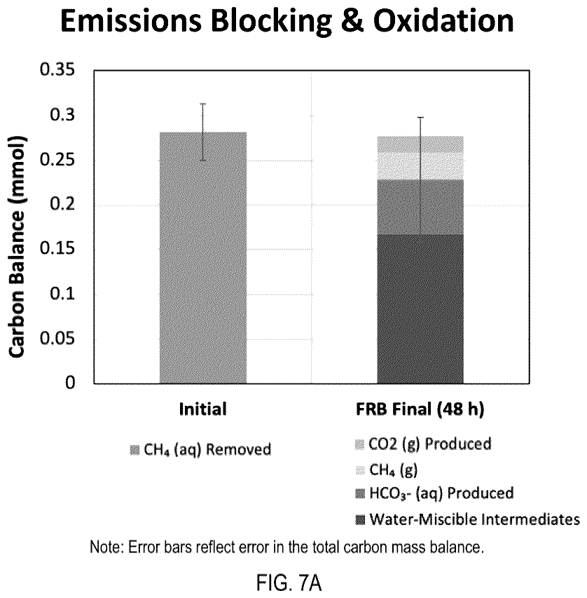

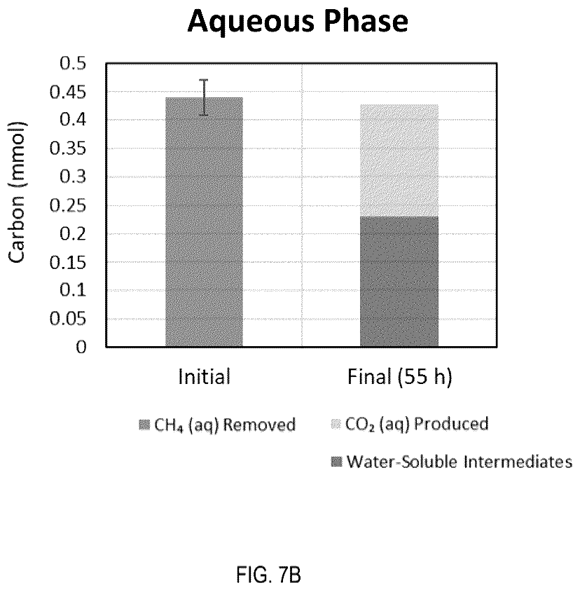

Referring to FIG. 7A, shown therein is a graph quantifying the reduction of methane emission by the BPRB 500 in FIG. 5. The data shown in FIG. 7A was produced in mass balanced lab experiments. At an initial time point when the BPRB is formed, the measured carbon balance consists solely of aqueous methane. 48 hours after the formation of the BPRB 500, the aqueous methane has been transformed into less-GHG intensive carbon dioxide gas, soluble water-miscible intermediates (e.g. methanol), soluble oxidized compounds (e.g., HCO₃₋) and methane gas (fraction that permeated through the BPRB) according to one or more of the above-described reactions. Compared to control experiments having no BPRB 500, aqueous methane is reduced by >70% (not shown).

Referring to FIG. 7B, shown therein is a graph quantifying the complete oxidation of methane to carbon dioxide using the BPRB 500 in FIG. 5. At an initial time point when the BPRB is formed, the measured carbon balance consists solely of aqueous methane. 55 hours after incubation with the BPRB 500, the aqueous methane has been transformed into aqueous carbon dioxide gas and water-soluble intermediates by the catalytic activity of the BPRB 500. This translates into a zero-order methane oxidation rate of ˜2.71 mg/L/d.

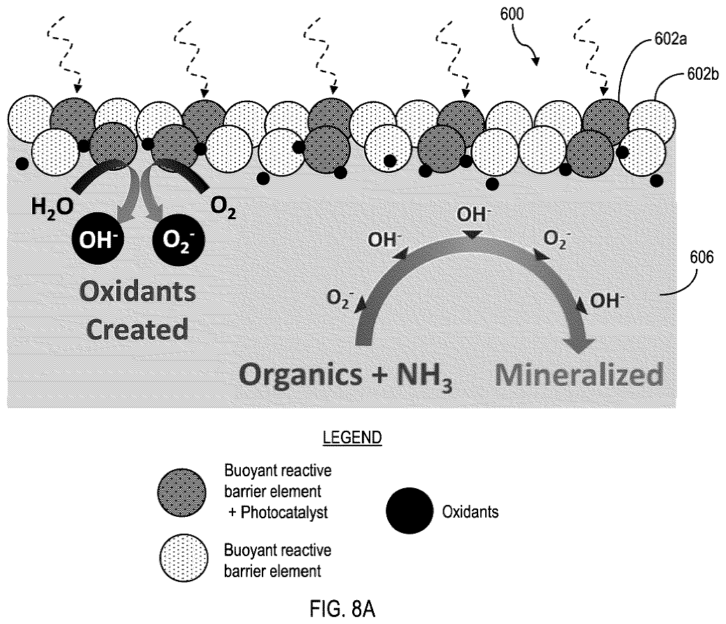

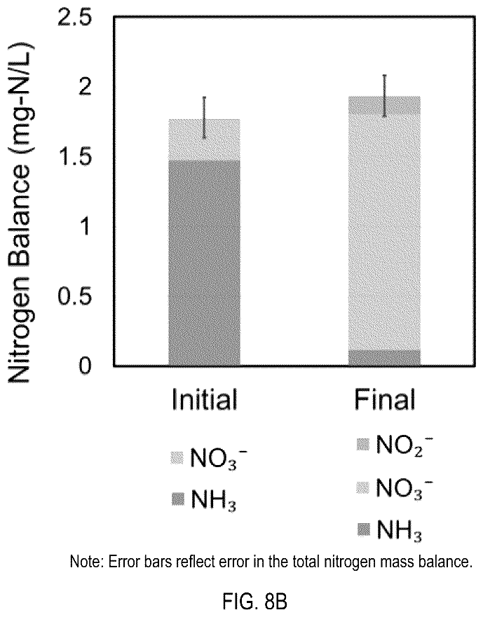

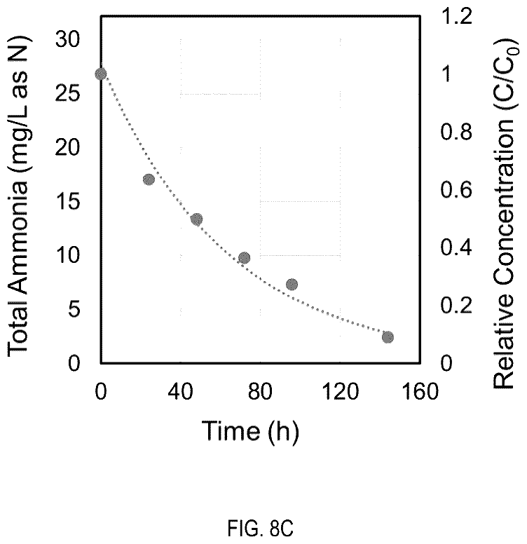

Referring to FIG. 8A, shown therein is a diagram of oxidative photocatalysis to transform ammonia to nitrate by a buoyant permeable reactive barrier (BPRB) 600, according to an embodiment. The BPRB 600 may be substantially similar to, or may be the BPRB 500 in FIG. 5. The BPRB 600 may be formed by a plurality of buoyant reactive barrier elements (BRBEs) 602a, 602b wherein at least a subset of the BRBEs 602a include a photocatalyst (e.g., TiO₂). The photocatalyst is activatable, upon absorbing solar radiation (dashed arrows), to catalyze a chemical reaction to transform aqueous ammonia in a body of water 606 into less volatile nitrite and nitrate products. Upon activation by sunlight, the photocatalyst produces oxidants (e.g., O₂⁻, OH⁺) that oxidize ammonia to nitrite and eventually nitrate (NH₃→NO₂⁻→NO₃⁻).

FIG. 8B, shows quantification of the reduction of ammonia by the BPRB 600 in FIG. 8A. The data shown in FIG. 8A was produced in mass balanced lab experiments. At an initial time point when the BPRB 600 is formed, the measured nitrogen balance consists primarily of aqueous ammonia. At the final timepoint, approximately 120 hours after formation of the BPRB, nearly all aqueous ammonia is transformed into less-volatile, nitrite and nitrate which may then mineralize with dissolved cations. FIG. 8C shows kinetics of the transformation of ammonia shown in FIG. 8B. The BPRB 600 oxidizes ammonia at a rate of ˜0.1 mg/L/h with pseudo-first order kinetics.

In some embodiments, the BPRBs described herein may act as a barrier for air, blocking or slowing the diffusion of atmospheric gases such as nitrogen and oxygen into the water below. Air-blocking properties may be imparted to the BPRB in various ways, for example: selecting the size of BRBE elements to reduce interstitial spacing, increasing the thickness of the BPRB to reduce the number of gaps and create a highly tortuous diffusion path, or ensuring more uniform layer coverage to minimize the water-air interfacial area. By preventing or slowing the diffusion of atmospheric gases, the BPRB may reduce levels of dissolved gases (e.g., dissolved oxygen) in the water. The BPRB need not be completely impermeable to atmospheric gases; the degree of air-blocking characteristics may be engineered to control levels of dissolved gases in the water.

In other embodiments, the BPRBs described herein may be used together with already established treatment methods as described in the prior art. For example, the BPRB may be used in conjunction with a treatment wetland, thereby augmenting the phytoremediation properties of the wetland with the catalytic properties of the BPRB for contaminant removal. In another embodiment, the BPRB may, in addition to imparting its own reactivity to treat permeating compounds, be used to reduce oxygen permeability from air into the water, thereby facilitating the development of anoxic conditions in the water, and promoting the development of anaerobic microorganisms, which may be beneficial to the anaerobic treatment or degradation of certain contaminants.

In some embodiments, the BPRB has oxygen-blocking characteristics and is used in conjunction with an anaerobic digestion process for the treatment of waste from a lagoon or pond. By slowing oxygen diffusion and reducing dissolved oxygen levels in the water, the BPRB promotes the growth of anaerobic microorganisms (e.g., methanogens) and their metabolic pathways. In such embodiments, the BPRB may also trap and oxidize biogas, the main product of anaerobic digestion. Biogas contains a large proportion of methane as well as small amounts of malodorous compounds (e.g., hydrogen sulfide) and thus its release into the atmosphere is a significant environmental concern. By trapping these gases to prevent their release and catalyzing their oxidation into less GHG-intensive (e.g., methane to carbon dioxide) or less volatile (e.g., sulfide to sulfate) products, the BPRB significantly reduces the environmental impact of anaerobic digestion.

It should be noted that various types of BRBEs described herein may be combined or assembled into a single BPRB. This is expected to be advantageous, for example, in multi-step treatment reactions, where one set of BRBEs containing one catalyst may facilitate one step of said reaction, while another set of BRBEs containing a different catalyst may facilitate another step of said reaction. In one embodiment, one set of BRBEs in a BPRB are buoyant photocatalyst microparticles, while another set of BRBEs in the same BPRB are biofilm-coated buoyant beads, wherein the photocatalytic BRBEs may “pre-treat” certain aqueous contaminants permeating into the BRBE for subsequent metabolic degradation by the microorganisms in the biofilm-included BRBEs. It must also be emphasized that BRBEs may be mixed or diluted with other non-reactive barrier elements. According to an embodiment, a small fraction of buoyant photocatalyst microparticles as BRBEs are included in a BPRB with a plurality of non-photocatalytic buoyant particles, wherein such a configuration of the BPRB may be advantageous to tailor the semi-permeability of the BPRB while saving on catalyst costs, or improving the mechanical stability of the BPRB against wind shear forces if the non-photocatalytic buoyant particles are sufficiently large (≥1 mm in size) to avoid piling up on themselves under wind forcing.

According to various embodiments, the BPRBs described herein may be engineered to operate for a specific period of time, indefinitely, or to self-destruct and naturally decompose at end of useful life. In one embodiment, the BPRB may be fabricated out of readily biodegradable fibers, polymers, and other materials, such that over time, natural microbial activity in the environment may deconstruct the BPRB. In another embodiment, the BPRB may be designed to be used primarily in a specific season, e.g., summertime, through use of a photocatalyst, wherein solar intensity could seasonally modulate reactivity of the photocatalyst, and hence also the barrier properties of the BPRB. In another embodiment, the BPRB may be designed to degrade under natural environmental weathering. For example, photocatalyst-coated buoyant hollow glass microspheres may be used as BRBEs, and may be designed to shatter when exposed to freezing (and/or thawing) conditions, such that the shattered BRBEs would no longer be buoyant, and the shattered detritus may settle naturally to the bottom of the body of water, for recovery or long-term disposal.

The BPRB may be manufactured and/or deployed to the surface of the water in a variety of fashions. In one embodiment, a pre-formed BPRB, consisting of interconnected BRBEs, may be manufactured and deployed to the surface of the water in a single large element or piece, by for example, using a boat to spread this element over the surface of the water. Manufacturing of such an integrated BPRB may consist of impregnating a pre-existing fabric, vapour barrier, or 2-dimensional mesh or network with reactive elements; assembling and cross-linking a collection of BRBEs, e.g., in a Langmuir trough; or producing an integrated BPRB using a roll-to-roll continuous printing process (either “printing” reactive elements or catalysts onto a permeable substrate, or perforating or etching an already reactive substrate to impart permeability).

In a preferred embodiment, the BPRB may be formed from independently floating, non-interlinked BRBEs, and may be deployed to the surface of the water as a powder, a fluidized powder or collection of particles, or a slurry, of the BRBEs. In a further preferred embodiment, the BRBEs are the composite materials disclosed in Canadian patent filing CA3041214A1, pre-formed as a slurry in water, and dispersed as a wet slurry or paste to the surface of the water, to minimize dust generation or occupational inhalation of particulate dust.

In a further embodiment, the BRBEs may be generated in situ in the body of water and self-assemble to form a BPRB near the water surface. For example, a stream of reactive chemicals, catalysts, and/or a gas may be injected below the water surface, forming bubbles, froth, or foam, which would concentrate naturally to the water surface due to buoyancy, forming a BPRB in situ.

In a preferred use, the BPRB may be formed from BRBEs consisting of the photocatalytic composite materials disclosed in Canadian patent filing CA3041214A1, dispersed onto the surface of a body of water as an aqueous slurry, therein forming a multilayer BPRB, wherein the permeability of volatile compounds through the BPRB from the water below to the air above would be reduced (relative to no BPRB as shown in FIG. 4) through slowed diffusion of these compounds via the tortuous interstitial pathways formed between the discrete, independent BRBEs. In this preferred use, the BPRB is used to photocatalytically treat malodorous volatiles permeating through the BPRB, absorbing sunlight from above to activate the photocatalytic elements within the BPRB, such that as the malodourous volatiles permeate through the BPRB, they encounter sunlight-activated photocatalysts, and are oxidized to less malodourous compounds. In a preferred embodiment, rather than treating malodourous volatile compounds, the BPRB may be used to photocatalytically oxidize methane to CO₂ as shown in FIG. 5. In another preferred embodiment, the BPRB may be used to photocatalyze the oxidation of ammonia to nitrate as shown in FIG. 8A.

While the above description provides examples of one or more apparatus, methods, or systems, it will be appreciated that other apparatus, methods, or systems may be within the scope of the claims as interpreted by one of skill in the art.

1. A buoyant permeable reactive barrier, comprising:
a plurality of buoyant reactive barrier elements at a surface of a body of water, wherein at least a subset of the buoyant reactive barrier elements includes a catalyst for oxidation of one or more volatile compounds,
wherein interstitial spacing between the plurality of reactive barrier elements slows the diffusion of the one or more volatile compounds across the buoyant permeable reactive barrier.

2. The buoyant permeable reactive barrier of claim 1, wherein the plurality of buoyant reactive barrier elements is arranged in one or more substantially planar layers.

3. The buoyant permeable reactive barrier of claim 1, wherein the one or more volatile compounds includes methane and the catalyst oxidizes the methane.

4. The buoyant permeable reactive barrier of claim 1, wherein the one or more volatile compounds includes sulfur and the catalyst oxidizes the sulfur.

5. The buoyant permeable reactive barrier of claim 1, wherein the one or more volatile compounds includes ammonia and the catalyst oxidizes the ammonia.

6. The buoyant permeable reactive barrier of claim 1, wherein the catalyst is a photocatalyst activatable by sunlight.

7. The buoyant permeable reactive barrier of claim 6, wherein the photocatalyst is selected from: titanium oxides, silver chloride, silver phosphate, iron oxides, bismuth oxides, tungstate, carbon nitrides, cerium oxides, cobalt oxides, or cobalt phosphates, manganese oxides, tin oxides, tungsten oxides, zinc oxides, or a combination thereof.

8. The buoyant permeable reactive barrier of claim 1, wherein the catalyst is an electrocatalyst, activatable by electric current.

9. The buoyant permeable reactive barrier of claim 1, wherein the plurality of buoyant reactive barrier elements are connected by chemical bonding, magnetism or physical tethers.

10. The buoyant permeable reactive barrier of claim 1, wherein the plurality of buoyant reactive barrier elements are constructed of hollow balls, hollow glass shells, plastic beads, microspheres, microparticles, microplastics, textiles, fabrics, geotextiles, membranes, fibers, plates or platelets.

11. The buoyant permeable reactive barrier of claim 1, further comprising a biofilm on the plurality of buoyant reactive barrier elements, wherein the biofilm includes a gelatinous extracellular polymeric matrix that fills the interstitial spaces between the plurality of buoyant reactive barrier elements.

12. The buoyant permeable reactive barrier of claim 11, wherein the catalyst is an enzyme embedded in the gelatinous extracellular polymeric matrix.

13. The buoyant permeable reactive barrier of claim 1, further comprising an adsorbent for retaining the one or more volatile compounds in reactive proximity to the catalyst.

14. The buoyant permeable reactive barrier of claim 13, wherein the adsorbent is selected from: activated carbons including N-doped, amine-modified, or S-doped, ion exchange resins, polyelectrolyte, zeolites or zero valent iron nanoparticles.

15. The buoyant permeable reactive barrier of claim 1, wherein each of the buoyant reactive barrier elements is permeable to at least one of the one or more volatile compounds.

16. The buoyant permeable reactive barrier of claim 1, further comprising a cordon of buoyant containment booms surrounding the plurality of buoyant reactive barrier elements.

17. The buoyant permeable reactive barrier of claim 1, wherein the plurality of buoyant reactive barrier elements are hydrophobic and slow the diffusion of water across the buoyant permeable reactive barrier.

18. The buoyant permeable reactive barrier of claim wherein the plurality of buoyant reactive barrier elements have a diameter between 10-500 μm.

19. The buoyant permeable reactive barrier of claim 1, wherein the plurality of buoyant reactive barrier elements comprise:
a first subset of buoyant reactive barrier elements for slowing diffusion of gas across the buoyant permeable reactive barrier; and
a second subset of buoyant reactive barrier elements for wind and wave resistance,
wherein the second subset of buoyant reactive barrier elements have a larger diameter than the first subset of buoyant reactive barrier elements.

20. The buoyant permeable reactive barrier of claim 19, wherein the first subset of buoyant reactive barrier elements have a diameter between 10-500 μm; and
wherein the second subset of buoyant reactive barrier elements have a diameter greater than 1 mm.
